(19) United States
(12) Patent Application Publication
(10) Pub. No.: US 2007/0191557 A1
(43) Pub. Date: Aug. 16, 2007

(54) Soft Thermoplastic Elastomer Having Improved Wear Resistance

(75) Inventor: Alex Kattenberg, Baarn (NL)

Correspondence Address: SPECKMAN LAW GROUP PLLC, 1201 THIRD AVENUE, SUITE 330, SEATTLE, WA, 98101, US

(73) Assignee: Rubberfabriek Wittenburg B.V., Nijkerkerveen (NL)

(21) Appl. No.: 11/676,220

(22) Filed: Feb. 16, 2007

(30) Foreign Application Priority Data
Feb. 16, 2006 (GB) 0603092.8
Dec. 16, 2006 (GB) 0625126.8

(51) Int. Cl. C08L 53/00

(52) U.S. Cl. 525/92 R

(57) ABSTRACT

A thermoplastic elastomer compound having a hardness value less than or equal to 95 Shore A, comprising a thermoplastic elastomer and between about 0.1% and about 20% by weight aramid filler in the form of a powder with a length/diameter ratio of approximately 1:1 is provided. The thermoplastic elastomer may suitably comprise one or more styrenic block copolymers or a traditional thermoset rubber incorporating a thermoplastic resin. Handlebar grips made of such compounds have improved wear resistant properties.

### CROSS REFERENCE TO RELATED APPLICATION(S)

This application claims foreign priority to United Kingdom Patent Application No. 0603092.8, filed Feb. 16, 2006, and United Kingdom Patent Application No. 0625126.8, filed Dec. 16, 2006.

### FIELD OF INVENTION

This invention generally relates to a thermoplastic elastomer compound for use in connection with the production of molded or extruded articles, such as hand grips or buttons. And particularly, this invention generally relates to a thermoplastic elastomer for use on articles to increase surface friction and/or to give better deformation for better grip properties.

### BACKGROUND OF THE INVENTION

A commonly used material for making handlebar grips (e.g. for motorcycles, bicycles and other vehicles, such as jet skis) is thermoplastic elastomer. This material provides a high surface friction and therefore gives the grip an anti-slip property. Furthermore, thermoplastic elastomer is very soft, which means the material can be deformed very easily and when it is used as a material for a grip, the material will deform to match the shape of a user's hand. In general, the softer a material, the easier the material will deform to match any shape applied to a grip, resulting in a better grip on a product. This behavior is particularly important for those grips where a sensitive control is needed. A grip made with such material, like a thermoplastic elastomer with a low hardness, can be deformed easily and causes less sliding.

The softness/deformability of thermoplastic elastomer with a low hardness, together with the high surface friction, means more force can be transferred to a grip. However, due to the higher force transferred and the relative softness of the material, grips made with this material tend to wear relatively more and/or relatively quicker than those produced from elastomer compounds of greater hardness.

It is thus desirable to increase the wear resistance of thermoplastic elastomer products without changing their surface properties. More specifically, it is desirable to increase the wear resistance of hand grips constructed of thermoplastic elastomers without decreasing the surface friction of the grips.

In the engineering plastics industry, the wear resistance of a plastic material is typically improved by addition of, for example, silicone, PTFE fillers, and/or aramid fillers. However, silicone acts as a liquefier by migrating to a surface making the surface slippery, reducing the surface friction and therefore decreasing the grippability of a product.

PTFE fillers are small particles which are embedded in the plastics material. These particles appear at the surface after an initial wear. Because thermoplastic elastomers can deform easily, these particles are ripped out of the thermoplastic matrix and do not significantly improve the wear resistance. In other words, the use of PTFE fillers is only suitable in respect of non-thermoplastic elastomers.

Aramid fillers are available as a powder and as fibers. Aramid fillers are commercially available under the brand names Kevlar® (Dupont de Nemours) and Twaron® (Teijin Twaron). The aramid powder is a reactor product, which is dissolved to make the aramid fibers. These aramid fibers are chopped in order to make them compoundable with the plastics material (normally engineering plastics) and such compounds are processable on injection molding and extrusion equipment. Because soft thermoplastic elastomers have a relatively low viscosity, there is usually insufficient shear at compounding conditions to disperse the aramid fibers in the matrix, resulting in relatively poor wear resistance, which is caused by the fact that the aramid fibers are ripped out of the matrix.

### SUMMARY OF THE INVENTION

A thermoplastic elastomer compound having a hardness value less than or equal to 95 Shore A, comprising a thermoplastic elastomer and between about 0.1% and about 20% by weight aramid filler in the form of a powder with a length/diameter ratio of approximately 1:1 is provided. It has been unexpectedly found that, by using aramid filler powder, with a length/diameter ratio of approximately 1:1 as the aramid filler, the correct dispersion can be achieved, resulting in excellent wear resistance of the resulting compound, while retaining required softness and high level of surface friction, which is important in high abrasive applications where a good grip is important as, for example, in handlebar grips.

In the present specification, the term ‘powder’ has its normal meaning of discrete particles of material with a maximum dimension of less than 1 mm.

### DETAILED DESCRIPTION OF THE INVENTION

A thermoplastic elastomer compound, comprising a thermoplastic elastomer and an aramid filler in the form of a powder, having a hardness value less than or equal to 95 Shore A is provided. In one embodiment, the inventive thermoplastic elastomer compound has a hardness value less than or equal to 80 Shore A.

In one embodiment, the inventive thermoplastic elastomer compound has an elastomer content between about 20% and about 99.9%. In another embodiment, the inventive thermoplastic elastomer compound has an elastomer content between about 30% and about 70%.

In one embodiment, the elastomer is a traditional thermoset rubber which is embedded into a thermoplastic matrix. In another embodiment, the elastomer is a styrenic based block copolymer, such as styrene-ethylene-butylene-styrene (SEBS) styrene-butadiene-styrene (SBS), styrene-ethylene-propylene-styrene (SEPS) or styrene-isoprene-styrene (SIS), styrene-ethylene-butylene (SEB), styrene-ethylene-butylene-styrene-ethylene-butylene (SEBSEB) or SEEPS (styrene-ethylene-ethylene-propylene-styrene), or any combinations thereof. The inclusion of a styrenic block copolymer, and particularly SEBS, as the elastomeric part of the compound is especially advantageous because such copolymers are superior compared to other rubbers in terms of mechanical, processing, thermal and UV stability properties.

In one embodiment, the inventive thermoplastic elastomer compound comprises a plasticizer level between about 0.1% and about 70%. In another embodiment, the inventive thermoplastic elastomer compound comprises a plasticizer level between about 15% and about 60%. In yet another embodiment, the inventive thermoplastic elastomer compound comprises a plasticizer level between about 30% and about 50%. The plasticizer may be, but is not limited to, a paraffinic oil.

In one embodiment, the inventive thermoplastic elastomer compound further comprises a thermoplastic resin, wherein the resin content is between about 2% and about 55%. In another embodiment, the resin content is between about 5% to about 10%. The thermoplastic resin may be, but is not limited to, polyolefines, such as polypropylene and/or polyethylene or polystyrene resins.

In alternative embodiments, instead of the thermoplastic elastomers described above, the thermoplastic elastomer compound comprises a thermoplastic resin between about 0.1% and about 99.9% by weight.

In one embodiment, the aramid powder used to increase the wear resistance of the thermoplastic elastomer may have a loading level in the inventive compound between about 0.1% and about 20% by weight. In another embodiment, the loading level is between about 0.5% and about 20% by weight. In yet another embodiment, the loading level is between about 1% and about 10% by weight. As described above, the aramid powder has a length/diameter ratio of approximately 1:1, which is an important factor of the inventive thermoplastic compound.

Commercially available aramid fibers typically have a thickness of about 7μ and are available from about 0.25 to 10 mm in length, representing a length/diameter ratio of from about 35:1 to 1450:1. At high values of the length/diameter ratio (above 200:1), the wear resistance of the compound in which these are included will decrease instead of increase. This is because of insufficient dispersion of the aramid fibers in the elastomer component and resulting poor processing properties of the thermoplastic elastomer compound and poor wear resistance, because the fibers are ripped out of the matrix.

As disclosed above, the inventive thermoplastic elastomer compound comprises aramid fillers in a powder form, instead of aramid fibers as described above. In one embodiment, the aramid fillers in a powder form have a length/diameter ratio of less than 35:1. In another embodiment, the aramid fillers in a powder form have a length/diameter ratio of about 20:1. In yet another embodiment, the aramid fillers in a powder form have a length/diameter ratio of about 10:1. In still another embodiment, the aramid fillers in a powder form have a length/diameter ratio of about 1:1.

This effect is unexpected because the current theory given by Dupont de Nemours and Teijn Twaron (the two suppliers of aramid fillers today) regarding the use of aramid filler to improve wear resistance is “the bigger the length/diameter ratio the better the wear resistance”. The theory is that aramid fibers will partially stick out of the surface of the plastic product. When the product is submitted to wear, the part of the fibers which sticks out of the surface, will orientate parallel to the surface in the direction of the wear. These parts of the fiber will act as skis and protect the product for wear, while the other part of the fiber keeps the fiber in place. Apparently this effect is expected and seen in most plastics, but in fact it does not apply for rubber like materials, like a SEBS compound. This may be due to the fact that thermoplastic elastomers are elastic. The elastic matrix may not be able to keep the fiber imbedded when part of the fiber is acting as a ski on the surface of the product.

The aramid powders which are used in the inventive thermoplastic compound are commercially available with diameters between about 55 and about 450 microns. It is unexpectedly found that these impart good wear resistant properties to the thermoplastic elastomer compound.

### EXAMPLE

A specific composition of inventive thermoplastic elastomer compound which has been found to have the necessary good wear resistant properties without deterioration in other surface properties and required softness is as follows:

% by weight

| | |
|---|---|
| 45% | SEBS |
| 45% | Oil |
| 5% | Polypropylene |
| 5% | Aramid powder |

Many other variations in composition are possible within the scope of the claimed invention and can readily be achieved by anyone skilled in the art.

The improvement of the wear resistance of thermoplastic elastomers filled with aramid powders can be seen in the following table. Table 1 shows the wear resistance data of the aramid filled and the unfilled materials at different hardness (Shore A according DIN 53505). Tests were performed according Wittenburg internal method (WIM 21) which is based on DIN 53516. Table 1. Wear resistance of unfilled and aramid filled thermoplastic elastomer compounds at different hardnesses (Shore A) according to WIM 21.

TABLE 1

| Hardness | Wear unfilled | Wear aramid filled | Improvement |
|---|---|---|---|
| [Shore A] | [mm³] | [mm³] | [%] |
| 95 | 85 | 50 | 41 |
| 85 | 100 | 60 | 40 |
| 75 | 120 | 75 | 38 |
| 65 | 140 | 85 | 39 |
| 55 | 165 | 95 | 39 |
| 45 | 200 | 130 | 35 |
| 35 | 260 | 170 | 35 |
| 25 | 340 | 210 | 38 |

Furthermore, grips for a motorbike were made from these aramid filler SEBS compounds. These were tested for wear resistance in practice and compared with grips made from a SEBS compound without these aramid filler. The aramid filled grip lasted 30 till 60% longer than the unfilled grip.

While certain embodiments of the present invention have been described, it will be understood that various changes could be made in the above constructions without departing from the scope of the invention. It is intended that all matter contained in the above description or shown in the accompanying drawings shall be interpreted as illustrative and not in a limiting sense.

I claim:

1. A thermoplastic elastomer compound having a hardness value less than or equal to 95 Shore A, comprising a thermoplastic elastomer and between about 0.1% and about 20% by weight aramid filler in the form of a powder, wherein the aramid filler in powder form has a length/diameter ratio of approximately 1:1.

2. The thermoplastic elastomer compound according to claim 1, wherein the thermoplastic elastomer comprises one or more of styrenic block copolymers, such as styrene-ethylene-butylene-styrene (SEBS), styrene-butadiene-styrene (SBS), styrene-ethylene-propylene-styrene (SEPS) or styrene-isoprene-styrene (SIS), styrene-ethylene-butylene (SEB), styrene-ethylene-butylene-styrene-ethylene-butylene (SEBSEB), or SEEPS (styrene-ethylene-ethylene-propylene-styrene).

3. The thermoplastic elastomer compound according to claim 1, wherein the thermoplastic elastomer comprises a thermoset rubber/polyolefine mixture, wherein the thermoset rubber can be either vulcanized or unvulcanized.

4. The thermoplastic elastomer compound according to claim 1, further comprising a plasticizer, such as a paraffinic oil, between about 0.1% and about 70% by weight.

5. The thermoplastic elastomer compound according to claim 1, further comprising a plasticizer, such as a paraffinic oil, between about 15% and about 60% by weight.

6. The thermoplastic elastomer compound according to claim 1, further comprising a plasticizer, such as a paraffinic oil, between about 30% and about 50% by weight.

7. The thermoplastic elastomer compound according to claim 1, further comprising a thermoplastic resin content between about 2% and about 55% by weight.

8. The thermoplastic elastomer compound according to claim 1, further comprising a thermoplastic resin content between about 5% and about 10% by weight.

9. The thermoplastic elastomer compound according to claim 1, wherein the thermoplastic elastomer compound comprises a thermoplastic resin between about 0.1% and about 99.9% by weight of the compound.

10. The thermoplastic elastomer compound according to claim 1, wherein the thermoplastic resin comprises one or more of polypropylene, polyethylene, polystyrene.

11. A handlebar grip fabricated from a thermoplastic elastomer compound according to claim 10.

12. A handlebar grip fabricated from a thermoplastic elastomer compound according to claim 1.

13. A thermoplastic elastomer compound having a hardness value less than or equal to 80 Shore A, comprising a thermoplastic elastomer and between about 0.1% and about 20% by weight aramid filler in the form of a powder, wherein the aramid filler in powder form has a length/diameter ratio of approximately 1:1.

14. The thermoplastic elastomer compound according to claim 13, wherein the thermoplastic elastomer comprises one or more of styrenic block copolymers, such as styrene-ethylene-butylene-styrene (SEBS), styrene-butadiene-styrene (SBS), styrene-ethylene-propylene-styrene (SEPS) or styrene-isoprene-styrene (SIS), styrene-ethylene-butylene (SEB), styrene-ethylene-butylene-styrene-ethylene-butylene (SEBSEB), or SEEPS (styrene-ethylene-ethylene-propylene-styrene).

15. The thermoplastic elastomer compound according to claim 13, wherein the thermoplastic elastomer comprises a thermoset rubber/polyolefine mixture, wherein the thermoset rubber can be either vulcanized or unvulcanized.

16. The thermoplastic elastomer compound according to claim 13, further comprising a plasticizer, such as a paraffinic oil, between about 0.1% and about 70% by weight.

17. The thermoplastic elastomer compound according to claim 13, further comprising a thermoplastic resin content between about 2% and about 55% by weight.

18. The thermoplastic elastomer compound according to claim 13, wherein the thermoplastic elastomer compound comprises a thermoplastic resin between about 0.1% and about 99.9% by weight of the compound.

19. A handlebar grip fabricated from a thermoplastic elastomer compound according to claim 13.

20. A thermoplastic elastomer compound comprising: a thermoplastic elastomer and between about 0.1% and about 20% by weight aramid filler in the form of a powder, wherein the aramid filler in powder form has a length/diameter ratio of less than 35:1.
